(19) United States
(12) Patent Application Publication
(10) Pub. No.: US 2026/0328310 A1
(43) Pub. Date: Oct. 22, 2026

(54) Two-way Interlocking Ball Valve Assembly

(71) Applicant: Wenzhou Ruilan Technology Co., Ltd, Wenzhou (CN)

(72) Inventors: Nan Zhang, Wenzhou (CN); Jiamin Li, Wenzhou (CN); Yuqi Chen, Wenzhou (CN)

(21) Appl. No.: 19/686,581

(22) Filed: May 22, 2026

(51) Int. Cl. F16K 35/06; F16K 27/06

(52) U.S. Cl. CPC F16K 35/06; F16K 27/067

(57) ABSTRACT

The invention discloses a bidirectional interlock ball valve assembly, comprising: a connector main body, valve assembly, movable latch, return spring, and locking assembly. When two connector main bodies are butted, each body has an annular protrusion. The valve assembly includes a rotary valve, handle, and connecting shaft. An unlocking protrusion is on the mounting end's outer wall. In a closed state, the unlocking protrusion abuts an upper end surface of an unlocking projection, rotating the movable latch to release lock on a first projection. In a communicated state, the unlocking protrusion leaves the surface, and the movable latch locks the first projection. The locking assembly includes a press block and an elastic member biasing the press block away from the mounting end. In both states, the locking end engages a corresponding locking groove to lock the valve handle, thereby improving safety.

### TECHNICAL FIELD

The invention relates to the technical field of valves, in particular to a two-way interlocking ball valve assembly.

### BACKGROUND TECHNOLOGY

With the wide application of fluid delivery system in engineering machinery, hydraulic pneumatic, chemical pipeline and other fields, the use frequency of pipeline connection and on-off control components is increasing, and users put forward higher requirements for the rapid assembly and disassembly of pipeline joints, sealing reliability and operational safety.

As the core component of integrated quick connection, on-off control and safety locking, the two-way interlocking ball valve assembly can realize the rapid docking and on-off switching of the pipeline, and has become the key basic component in the fluid delivery system.

Chinese Patent Publication No. CN120487994B discloses a replacement joint with two-way interlocking, which is arranged on the main body of the joint by screwing the first protrusion and the first groove into each other, and uses the lever structure of the rotary valve and the movable lock catch to limit the circumferential rotation freedom of the first protrusion and realize two-way interlocking, but the structure is not provided with an independent handle locking structure, there is also a lack of a secondary insurance mechanism for the handle to directly lock the lock hook.

Under vibration and impact conditions, there is still the risk of the handle turning by mistake, the lock hook accidentally rebounding and loosening, and the safety protection is not perfect.

### INVENTION CONTENT

In order to overcome the shortcomings of the prior art, the object of the present invention is to provide a two-way interlocking ball valve assembly, which improves the safety protection ability.

The object of the invention is achieved by the following technical scheme:
A two-way interlocking ball valve assembly, comprising:
   The joint body, the butt end of the joint body is provided with at least one first protrusion and at least one first groove; the first groove extends along the circumference of the joint body; when the butt ends of the two joint bodies are butted, the first protrusion located on one of the joint bodies is inserted and screwed into the first groove located in the other joint body; the outer wall of the joint body is also provided with an annular protrusion, and the annular protrusion extends circumferentially along the handle mounting hole of the joint body; the inner side wall of the annular protrusion is provided with a plurality of locking grooves, The locking grooves are distributed at intervals along the circumferential direction of the annular protrusion;
   A valve assembly, the valve assembly includes a rotary valve, a valve handle, and a connecting shaft; the rotary valve is installed on the joint body; the mounting end of the valve handle is sleeved on the annular protrusion; the connecting shaft passes through the The handle mounting hole, the valve handle is connected to the rotary valve through the connecting shaft; the valve handle can rotate relative to the joint body, to control the rotary valve to switch between a closed state and a connected state; the outer wall of the mounting end is provided with an unlocking protrusion;
   The movable lock buckle is pivotally connected to the joint body through a pivot shaft; the pivot shaft extends along the length direction of the joint body, and the movable lock buckle can rotate around the axis of the pivot shaft relative to the joint body; the unlocking end of the movable lock buckle is provided with an unlocking protrusion, and the unlocking protrusion extends along the extension direction of the pivot shaft and extends close to the valve handle; the lock hook end of the movable lock buckle is used to lock the first protrusion of the other joint body that is connected; in the closed state, the unlocking protrusion abuts against the upper end surface of the unlocking protrusion, so that The movable lock buckle rotates to release the lock of the first protrusion; in the connected state, the unlocking protrusion leaves the upper end surface of the unlocking protrusion, the movable locking buckle locks the first bump;
   A reset elastic member, the reset elastic member is arranged between the movable lock catch and the pivot shaft, and the reset elastic member is used to drive the lock hook end to maintain a tendency to rotate in the locking direction;
   The locking assembly includes a pressing block and an elastic member, the pressing block is movable to the mounting end, and the locking end of the pressing block passes through the outer wall of the mounting end and extends into the inside of the mounting end; the elastic member is clamped by the pressing block and the mounting end, so that the pressing block has a tendency to move away from the mounting end; in the closed state and the connected state, the locking end is locked into the locking groove at the corresponding position to realize the locking of the valve handle.

Further, the outer wall of the mounting end is further provided with a clamping protrusion, and the clamping protrusion extends in a direction away from the mounting end; in the connected state, the clamping protrusion abuts against the lower end surface of the unlocking end; in the closed state, the clamping protrusion is away from the lower end surface of the unlocking end.

Further, the inner side wall of the mounting end is provided with an avoidance groove, and the avoidance groove extends along the circumferential direction of the mounting end; the outer wall of the annular protrusion is provided with a limiting protrusion, and the limiting protrusion is located In the avoidance groove, the limiting protrusion is used to limit the rotation angle of the valve handle.

Further, the butt end of the joint body is further provided with at least one second protrusion and at least one second groove; the second groove extends along the circumference of the joint body; when the butt ends of the two joint bodies are butted, the second protrusion on one of the joint bodies is inserted and screwed into the second groove on the other joint body; the first bump, the first groove, the second bump and the second groove are spaced apart along the circumference of the joint body; the first bump and the second bump extend along the circumference of the joint body, and the extension length of the second bump is greater than that of the first bump.

Further, the mounting end is provided with a mounting through hole, and the pressing block is movable in the mounting through hole; the elastic member is a spring, one end of the spring abuts against the pressing block, and the other end abuts against the inner wall of the mounting end.

Further, the number of the locking grooves is two, and the two locking grooves respectively correspond to the position of the valve handle in the closed state and the position of the valve handle in the connected state.

Further, the upper end surface of the unlocking protrusion is an arc-shaped surface or a flat surface.

Further, the end of the locking end is provided with a guide chamfer.

Further, the reset elastic member is a torsion spring, the torsion spring is sleeved on the pivot shaft, one end of the torsion spring abuts against the joint main body, and the other end abuts against the lock hook end of the movable lock catch.

Further, the butt end of the joint body is provided with a sealing groove, and a sealing ring is installed in the sealing groove for end face sealing when the two joint bodies are butt-jointed.

Compared with the prior art, the beneficial effects of the present invention are:
1. Based on the joint body, at least one first protrusion and at least one first groove are provided on the butt end of the joint body; the first groove extends along the circumference of the joint body; when the butt ends of the two joint bodies are butted, the first protrusion located on one of the joint bodies is inserted and screwed into the first groove located in the other joint body; the pivot shaft extends along the length direction of the joint body, and the movable lock buckle can rotate relative to the joint body around the axis of the pivot shaft; the lock hook end of the movable lock buckle is used to lock the first protrusion of the other joint body that is butted; In the closed state, the unlocking protrusion abuts the upper end surface of the unlocking protrusion to rotate the movable lock buckle and release the lock of the first protrusion.

By providing the first protrusion and the first groove extending along the circumferential direction at the butt end of the joint body, the two joint bodies can be quickly inserted and screwed during the butt joint, which effectively improves the assembly efficiency and the butt joint accuracy.

At the same time, the movable lock is pivotally connected to the joint body through the pivot shaft and can rotate around the axis of the pivot shaft, the locking hook end can directly lock the first protrusion of the other joint body to prevent it from falling off.

In the closed state, the unlocking protrusion abuts the upper end surface of the unlocking protrusion to drive the movable lock to rotate and release the first The locking of the convex block realizes the linkage between the valve closed state and the joint unlocked state, without the need to operate the locking structure separately, simplifying the disassembly steps, it avoids component damage caused by forced disassembly of the locking structure without unlocking, and at the same time ensures the synchronization and stability of the docking and unlocking actions, which greatly improves the convenience and safety of the ball valve assembly during use.
2. The outer wall based on the mounting end is provided with an unlocking protrusion; the unlocking end of the movable lock is provided with an unlocking protrusion, which extends along the extension direction of the pivot shaft and extends close to the valve handle; the reset elastic member is arranged between the movable lock and the pivot shaft, and the reset elastic member is used to drive the end of the lock hook to maintain the tendency of rotating towards the locking direction.

The unlocking protrusion provided on the outer wall of the mounting end is matched with the unlocking protrusion provided on the unlocking end of the movable latch, and the unlocking protrusion extends along the extension direction of the pivot shaft and is close to the valve handle, which can ensure that the unlocking protrusion is accurately docked with the unlocking protrusion when rotating with the valve handle, realize the synchronous linkage between the valve state and the movable latch action, and avoid the situation of linkage jam or dislocation;
the reset elastic piece is arranged between the movable lock catch and the pivot shaft to continuously provide driving force for the movable lock catch, so that the end of the lock hook always keeps the trend of rotating towards the locking direction, and ensures that when there is no abutment action of the unlocking protrusion, the movable lock catch can stably lock the first protrusion of the docking and prevent accidental loosening of the docking structure.

At the same time, after the unlocking protrusion is released from abutment, the reset elastic member can drive the movable lock buckle to quickly reset and re-lock without manual intervention, which not only improves the response speed of the interlocking structure, but also enhances the working reliability of the entire ball valve assembly, simplifies the operation process, and avoids human operation The lock failure problem caused by error.
3. The inner side wall based on the annular protrusion is provided with a plurality of locking grooves, and the plurality of locking grooves are distributed at intervals along the circumference of the annular protrusion; the locking assembly includes a pressing block and an elastic member, and the pressing block can be moved Installed on the installation end, and the locking end of the pressing block passes through the outer wall of the installation end and extends into the inside of the installation end; the elastic piece is clamped by the pressing block and the mounting end, in order to make the pressing block tend to be far away from the installation end; in the closed state and the connected state, the locking end is locked into the locking groove at the corresponding position to realize the locking of the valve handle.

The plurality of locking grooves on the annular protrusion are distributed at intervals along the circumferential direction, which can accurately match the different states of the valve handle, and ensure that the locking end of the pressing block can be locked into the corresponding locking under both closed and connected working conditions.

The groove realizes effective fixation of the valve handle; the elastic member provides continuous outward force for the pressing block, which can prevent the pressing block from shifting due to vibration, collision and other factors, ensure the stable fit of the locking end and the locking groove;
and the design of the locking end and the locking groove can effectively fix the position of the valve handle, prevent accidental rotation, and avoid the interlocking failure caused by the handle movement.

Problems such as fluid leakage not only further improve the self-locking function of the ball valve assembly, but also improve the stability and reliability of the overall structure, ensure that the state of the valve handle is consistent with the overall interlock logic, which improves the safety protection ability.

### FIGURE CAPTION

FIG. 1 is a structural schematic diagram of a two-way interlocking ball valve assembly of the present invention, wherein the valve handle of the right joint body is a structural schematic diagram in a connected state;

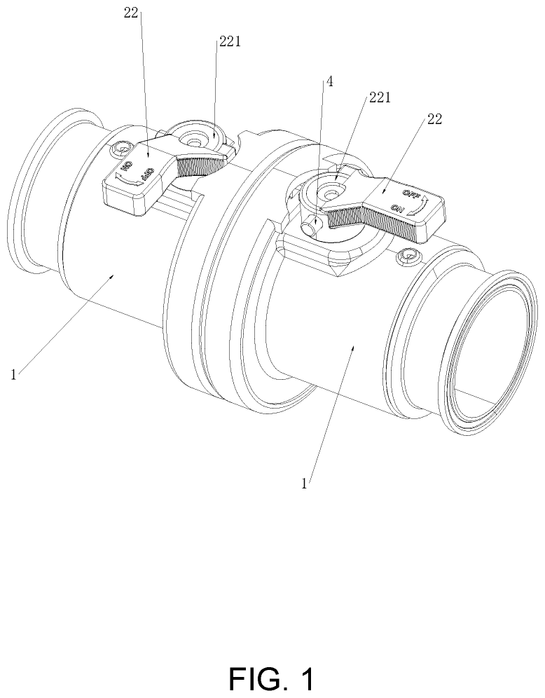

FIG. 2 is the explosive diagram shown in FIG. 1;

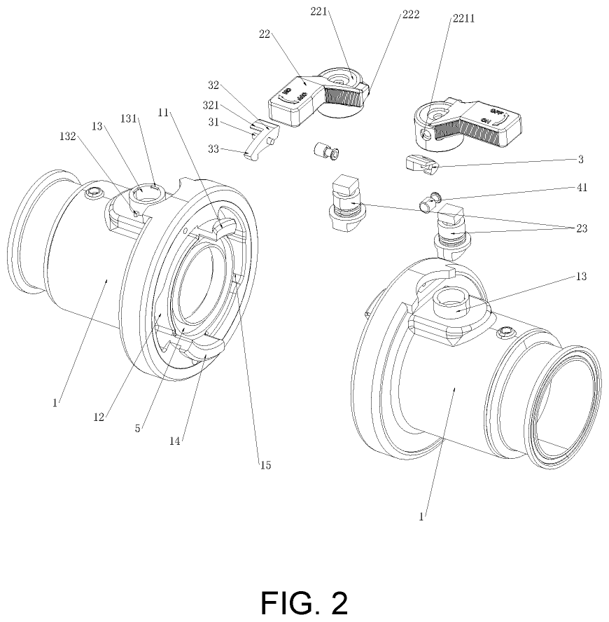

FIG. 3 is a cross-sectional view shown in FIG. 1;

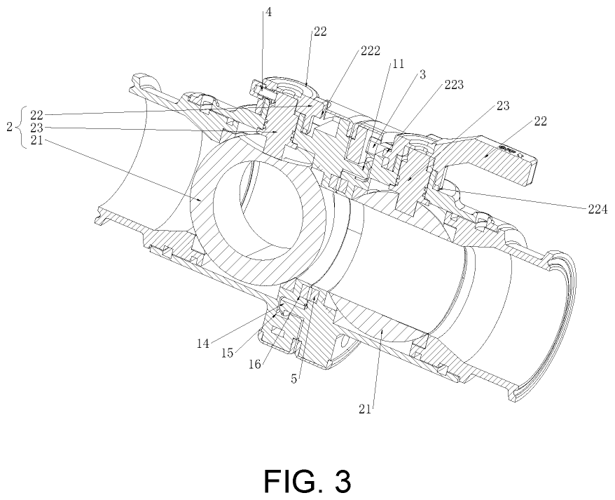

FIG. 4 is a schematic structural diagram of the valve handle and the movable lock shown in FIG. 1, wherein the valve handle is in a connected state;

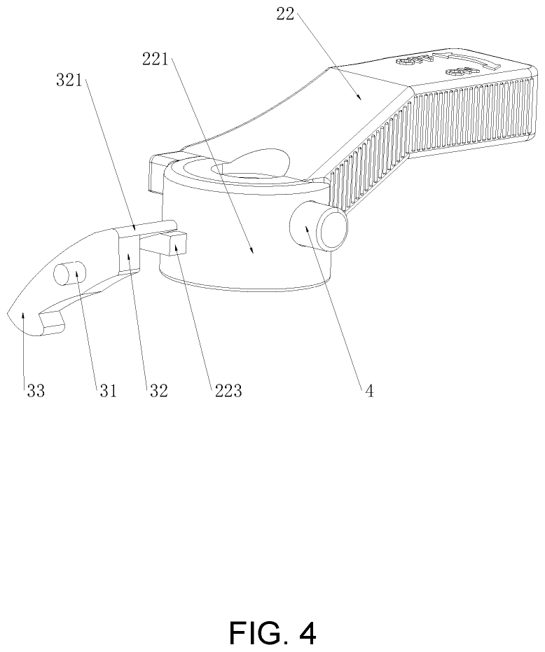

FIG. 5 is a schematic structural view of the valve handle and the movable latch shown in FIG. 1, wherein the valve handle is in a closed state.

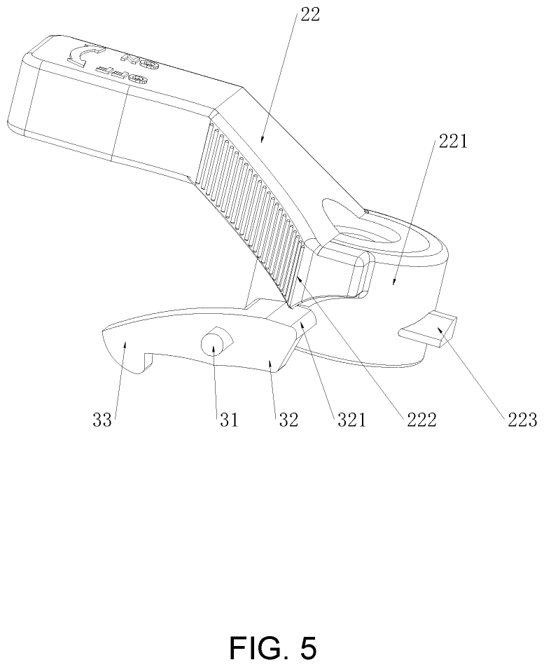

In the figure: 1. Joint body; 11. First protrusion; 12. First groove; 13. Annular protrusion; 131. Locking groove; 132. Limit protrusion; 14. Second protrusion; 15. Second groove; 16. Sealing groove; 2. Valve assembly; 21. Rotary valve; 22. Valve handle; 221. Installation end; 2211. Installation through hole; 222. Unlocking protrusion; 223, clamping protrusion; 224, avoiding groove; 23. Connecting shaft; 3. Active locking buckle; 31. Pivoting shaft; 32. Unlocking end; 321. Unlocking protrusion; 33. Lock hook end; 4. Locking assembly; 41. Pressing block; 5. Sealing ring.

### SPECIFIC IMPLEMENTATION METHOD

In the following, the present invention is further described with reference to the accompanying drawings and specific implementation manners.

It should be noted that, on the premise of no conflict, new embodiments may be formed by any combination between the embodiments or technical features described below.

It should be noted that when an element is referred to as being “fixed” to another element, it may be directly on the other element, or there may also be a centered element.

When an element is said to be “connected” to another element, it may be directly connected to the other element or there may be an intervening element.

As used herein, “vertical,” “horizontal,” “left,” “right,” and the like are for illustrative purposes only, and do not represent the only embodiments.

Unless otherwise defined, all technical and scientific terms used herein have the same meaning as commonly understood by those skilled in the art to which the present invention belongs.

The terminology used herein in the description of the invention is for the purpose of describing particular embodiments only and is not intended to be limiting of the invention.

The term “and/or” used herein includes any and all combinations of one or more related listed items.

1-5, a two-way interlocking ball valve assembly of the present invention comprises: a joint body 1, a valve assembly 2, a movable lock catch 3, a reset elastic member and a locking assembly 4.

At least one first protrusion 11 and at least one first groove 12 are arranged on the butt end of the joint body 1; the first groove 12 extends along the circumference of the joint body 1; when the butt ends of the two joint bodies 1 are butted, the first protrusion 11 on one joint body 1 is inserted into and screwed into the first groove 12 on the other joint body 1; the outer wall of the joint body 1 is further provided with an annular protrusion 13, the annular protrusion 13 extends along the circumferential direction of the handle mounting hole of the joint body 1; the inner side wall of the annular protrusion 13 is provided with a plurality of locking grooves 131, and the plurality of locking grooves 131 are distributed at intervals along the circumferential direction of the annular protrusion 13.

By integrating the joint body 1, the valve assembly 2, the movable lock catch 3, the reset elastic member and the locking assembly 4, an integrated two-way interlocking ball valve assembly structure is formed, in which the joint body 1 is used as the installation foundation of the whole assembly and the fluid circulation carrier, and the first protrusion 11 and the first groove 12 arranged at the butt end adopt the matching form of circumferential extension, it can realize the quick connection between the two joint bodies 1 and complete the preliminary positioning and axial limit through the screwing action, which effectively improves the efficiency of butt assembly.

At the same time, the annular protrusion 13 is circumferentially extended around the handle mounting hole, which can provide a stable support structure for the assembly of the valve assembly 2.

The inner side wall of the annular protrusion 13 has multiple locking grooves 131 spaced along the circumferential direction, it can form a circumferential positioning and locking cooperation with subsequent cooperation components, so as to ensure the stable position of the valve assembly 2 during the working process, and avoid accidental deviation of the valve state due to external force touch or fluid impact.

The valve assembly 2 comprises a rotary valve 21, a valve handle 22 and a connecting shaft 23; the rotary valve 21 is mounted on the joint body 1; the mounting end 221 of the valve handle 22 is sleeved on the annular protrusion 13; the connecting shaft 23 is provided with a handle mounting hole, and the valve handle 22 is connected to the rotary valve 21 through the connecting shaft 23; the valve handle 22 can rotate relative to the joint body 1, to control the rotary valve 21 to switch between the closed state and the connected state; the outer wall of the mounting end 221 is provided with an unlocking protrusion 222.

The rotary valve 21 undertakes the key functions of fluid circulation and cut-off, and is installed on the connector body 1 and can directly correspond to the fluid channel inside the connector body 1 to control the fluid; the installation end 221 of the valve handle 22 is sleeved on the annular protrusion 13, which can not only realize the stable assembly of the valve handle 22 by means of the annular protrusion 13, but also ensure the smooth rotation of the valve handle 22 around the annular protrusion 13, the connecting shaft 23 is provided with a handle mounting hole and connects the valve handle 22 with the rotary valve 21, and a linkage transmission structure between the valve handle 22 and the rotary valve 21 is constructed, so that when the operator rotates the valve handle 22, the rotary valve 21 can be driven to rotate synchronously through the connecting shaft 23, thereby switching the rotary valve 21 between the closed state and the connected state.

The unlocking protrusion 222 provided on the outer wall of the mounting end 221 is mainly used for forming a linkage with a subsequent mating component, providing a trigger point for the unlocking action of the subsequent interlocking structure, and ensuring smooth linkage between the interlocking and unlocking actions.

The movable buckle 3 is pivotally connected to the joint body 1 through a pivot shaft 31; the pivot shaft 31 extends along the length direction of the joint body 1, and the movable buckle 3 can rotate relative to the joint body 1 around the axis of the pivot shaft 31; the unlocking end 32 of the movable buckle 3 is provided with an unlocking protrusion 321, and the unlocking protrusion 321 extends along the extension direction of the pivot shaft 31 and extends close to the valve handle 22; the lock hook end 33 of the movable lock catch 3 is used to lock the first protrusion 11 of the other joint body 1; in the closed state, the unlocking protrusion 222 abuts against the upper end surface of the unlocking protrusion 321, so that the movable lock catch 3 rotates and the first protrusion 11 is unlocked; in the connected state, the unlocking protrusion 222 is away from the upper end surface of the unlocking protrusion 321, the movable lock catch 3 locks the first protrusion 11.

The lock hook end 33 of the movable lock buckle 3 is specially used to lock the first protrusion 11 of the other joint body 1 of the docking, so as to realize the locking fixation during the bidirectional docking and avoid the unscrewing during the docking process;
In the closed state, the unlocking protrusion 222 on the valve handle 22 will abut the upper end surface of the unlocking protrusion 321, driving the movable lock buckle 3 to rotate around the pivot shaft 31, in this way, the locking of the first protrusion 11 is released, and the separation or adjustment of the two joint bodies 1 is convenient;
in the connected state, the unlocking protrusion 222 and the unlocking protrusion 321 are separated, and the movable lock 3 is in its own elasticity (or reset force) Reset, re-lock the first protrusion 11, ensure the stability of the docking structure, and realize flexible locking and unlocking switching, it also guarantees the working reliability of the entire component and avoids the effect of accidental loosening.

The reset elastic member is arranged between the movable lock catch 3 and the pivot shaft 31, and the reset elastic member is used for driving the lock hook end 33 to keep the tendency of rotating toward the locking direction.

Provide continuous elastic force for the movable latch 3 to ensure that the hook end 33 always keeps the rotation trend in the locking direction, so as to prevent the movable latch 3 from shifting and locking failure due to external touch or vibration;
when the movable latch 3 slightly rotates and deviates from the locking position due to operation or external force, the reset elastic part will generate reverse elastic force to pull the hook end 33 of the movable latch 3 back to the locking state, the locking hook end 33 is guaranteed to stably lock the first protrusion 11, and at the same time, it cooperates with the rotation action of the movable locking buckle 3, so that the entire locking and unlocking process is smoother, and the stability and reliability of the two-way interlocking structure are further improved.

The locking assembly 4 comprises a pressing block 41 and an elastic member, the pressing block 41 is movable mounted on the mounting end 221, and the locking end of the pressing block 41 passes through the outer wall of the mounting end 221 and extends into the inside of the mounting end 221; the elastic member is clamped by the pressing block 41 and the mounting end 221, so that the pressing block 41 has a tendency to move away from the mounting end 221, the locking end is locked into the locking groove 131 at the corresponding position to realize the locking of the valve handle 22.

The locking end passes through the outer wall of the mounting end 221 and extends into the inside, and can cooperate with the locking groove 131 to realize the position fixation of the valve handle 22.

The elastic piece is clamped by the pressing block 41 and the mounting end 221, which can continuously provide outward force for the pressing block 41, ensure that the pressing block 41 always keeps away from the mounting end 221, and avoid the displacement of the pressing block 41 due to vibration and collision, in turn, it is ensured that the locking end can be stably locked into the locking groove 131;
in the closed state and the connected state, the locking end is locked into the locking groove 131 at the corresponding position, which can firmly fix the position of the valve handle 22, prevent it from rotating, avoid problems such as interlock failure and fluid leakage caused by accidental movement of the valve handle 22, and ensure the normal operation of the ball valve assembly, it further improves the overall self-locking protection function, forms a complete protection system with the structure of the joint body 1 and the movable lock 3, and improves the safety protection ability.

The working principle of the two-way interlocking ball valve assembly of the present invention is: in the closed state, the valve handle 22 drives the unlocking protrusion 222 to abut the unlocking protrusion 321 of the movable lock 3, so that the movable lock 3 rotates around the pivot shaft 31 And release the lock of the first bump 11 of the other joint body 1, at this time, the locking end of the locking component 4 is locked into the corresponding locking groove 131 to fix the valve handle 22, ensuring that the closed state is stable and the connector body 1 can be smoothly separated;
when switching to the connected state, the valve handle 22 rotates to drive the unlocking protrusion 222 away from the unlocking protrusion 321, and the reset elastic member drives the locking hook end 33 of the movable locking buckle 3 to rotate in the locking direction and lock the first protrusion 11, realize the two-way interlocking of the two joint bodies 1, and at the same time, the locking end is locked into the locking groove 131 corresponding to the connected state, and the valve handle 22 is locked in the connected position, relying on the continuous force of the elastic member to the pressing block 41 and the reset elastic The continuous driving force of the piece to the movable lock 3, ensure that the on-off state of the valve is synchronized and stable with the joint interlocking state (the main body joint can be disassembled only when the two main body joints are connected to close the valve), and no misoperation occurs due to external force or vibration, so as to realize the linkage operation of fluid on-off control and joint interlocking, and the locking control of the valve handle 22.

Based on the joint body 1, at least one first protrusion 11 and at least one first groove 12 are provided on the butt end of the joint body 1; the first groove 12 extends along the circumference of the joint body 1; when the butt ends of the two joint bodies 1 are butted, the first protrusion 11 located on one joint body 1 is inserted into and screwed into the first groove 12 located in the other joint body 1; the movable lock catch 3 is pivotally connected to the joint body 1 through the pivot shaft 31; the pivot shaft 31 extends along the length direction of the joint body 1, and the movable lock catch 3 can rotate relative to the joint body 1 around the axis of the pivot shaft 31; the lock hook end 33 of the movable lock catch 3 is used to lock the first protrusion 11 of the other joint body 1 of the butt joint; in the closed state, the unlocking protrusion 222 abuts against the upper end surface of the unlocking protrusion 321, so that the movable lock catch 3 rotates, and the locking of the first protrusion 11 is released.

By arranging the first protrusion 11 and the first groove 12 extending along the circumferential direction at the butt end of the joint body 1, the two joint bodies 1 can be quickly inserted and screwed during butt joint, which effectively improves the assembly efficiency and butt joint accuracy.

At the same time, the movable lock 3 is pivotally connected to the joint body 1 through the pivot shaft 31 and can rotate around the axis of the pivot shaft 31, the locking hook end 33 can directly lock the first protrusion 11 of the other joint body 1 to prevent the joint from coming off.

In the closed state, the unlocking protrusion 222 abuts against the upper end surface of the unlocking protrusion 321 to drive the movable locking buckle 3 to rotate and release the locking of the first protrusion 11, thus realizing the linkage between the valve closed state and the joint unlocked state without the need to operate the locking structure separately, the disassembly step is simplified, the component damage caused by the forced disassembly of the locking structure is not unlocked, and the synchronization and stability of the docking and unlocking actions are ensured, and the convenience and safety of the ball valve assembly are greatly improved.

The unlocking end 32 of the movable lock catch 3 is provided with an unlocking protrusion 222, the unlocking protrusion 321 extends along the extension direction of the pivot shaft 31 and extends close to the valve handle 22; the reset elastic member is provided between the movable lock catch 3 and the pivot shaft 31, and the reset elastic member is used for driving the lock hook end 33 to keep the tendency of rotating towards the locking direction.

The unlocking protrusion 222 arranged on the outer wall of the mounting end 221 is matched with the unlocking protrusion 321 arranged on the unlocking end 32 of the movable locking buckle 3, and the unlocking protrusion 321 extends along the extension direction of the pivot shaft 31 and is close to the valve handle 22, which can ensure that the unlocking protrusion 222 is accurately docked with the unlocking protrusion 321 when the valve handle 22 rotates, and realize the synchronous linkage between the valve state and the action of the movable locking buckle 3, avoid the situation of linkage blocking or dislocation;

The reset elastic piece is arranged between the movable lock catch 3 and the pivot shaft 31 to continuously provide driving force for the movable lock catch 3, so that the lock hook end 33 always keeps the trend of rotating towards the locking direction, and ensures that when there is no abutment action of the unlocking protrusion 222, the movable lock catch 3 can stabilize the first protrusion 11 of the locking docking and prevent the docking structure from loosening accidentally, at the same time, after the unlocking protrusion 222 is released from abutment, the reset elastic member can drive the movable lock buckle 3 to quickly reset and re-lock without manual intervention, which not only improves the response speed of the interlocking structure, but also enhances the working reliability of the entire ball valve assembly, Simplify the operation process and avoid the problem of locking failure caused by human operation errors.

A plurality of locking grooves 131 are provided on the inner side wall of the annular protrusion 13, and the plurality of locking grooves 131 are distributed at intervals along the circumference of the annular protrusion 13; the locking assembly 4 includes a pressing block 41 and an elastic piece, The pressing block 41 can be installed on the installation end 221 in a movable manner, and the locking end of the pressing block 41 passes through the outer wall of the installation end 221 and extends into the inside of the installation end 221; the elastic member is clamped by the pressing block 41 and the mounting end 221, so that the pressing block 41 has a tendency to move away from the mounting end 221; in the closed state and the connected state, the locking end is locked into the locking groove 131 at the corresponding position to realize The valve handle 22 is locked.

The plurality of locking grooves 131 on the annular protrusion 13 are distributed at intervals along the circumferential direction, which can accurately match the different states of the valve handle 22, and ensure that the locking end of the pressing block 41 can be locked under both closed and connected working conditions.

The corresponding locking groove 131 realizes effective fixation of the valve handle 22; the elastic member provides continuous outward force for the pressing block 41, it can avoid the displacement of the pressing block 41 due to vibration, collision and other factors, and ensure the stable fit of the locking end and the locking groove 131;
and the design of the locking end and the locking groove 131 can effectively fix the valve handle 22 The position prevents accidental rotation, thereby avoiding problems such as interlock failure and fluid leakage caused by handle movement, this not only further improves the self-locking function of the ball valve assembly, but also improves the stability and reliability of the overall structure, ensures that the state of the valve handle 22 is consistent with the overall interlock logic, and improves the safety protection capability.

Preferably, the outer wall of the mounting end 221 is further provided with a clamping protrusion 223, and the clamping protrusion 223 extends in a direction away from the mounting end 221; in the connected state, the clamping protrusion 223 abuts against the lower end surface of the unlocking end 32; and in the closed state, the clamping protrusion 223 is away from the lower end surface of the unlocking end 32.

The outer wall of the mounting end 221 is provided with a clamping protrusion 223 extending in a direction away from the mounting end 221, and the clamping protrusion 223 can be used to abut the lower end surface of the unlocking end 32 in the connected state, which further forms the movable lock 3.

Auxiliary limiting and pressing effects enhance the locking reliability of the lock hook end 33 to the first protrusion 11, avoid the accidental loosening of the movable latch 3 due to fluid impact or external vibration in the connected working state, and the clamping protrusion 223 is separated from the unlocking end 32 in the closed state, which will not interfere with the unlocking rotation of the movable latch 3 and ensure the smooth unlocking action.

The structure realizes the double reinforcement of the interlocking structure in the connected state without adding complicated transmission components, the stability and safety of the two-way interlock are further improved.

Preferably, the inner side wall of the mounting end 221 is provided with an avoidance groove 224, and the avoidance groove 224 extends along the circumferential direction of the mounting end 221; the outer wall of the annular protrusion 13 is provided with a limiting protrusion 132, the limiting protrusion 132 is located in the avoidance groove 224, and the limiting protrusion 132 is used to limit the rotation angle of the valve handle 22.

By opening the avoidance groove 224 extending along the circumferential direction on the inner side wall of the installation end 221, and setting the limit bump 132 located in the avoidance groove 224 on the outer wall of the annular protrusion 13, the limit bump 132 and the avoidance groove 224 can be used The cooperation of the valve handle 22 accurately limits the rotation range, avoid the dislocation of the unlocking protrusion 222 and the unlocking protrusion 321 caused by excessive rotation of the valve handle 22, and the locking end and the locking groove 131 cannot be correspondingly engaged.

At the same time, the avoidance groove 224 provides a reasonable movement space for the normal rotation of the valve handle 22 without motion interference.

The limit structure is simple and reliable, and can effectively ensure that the valve handle 22 is only stably switched between the closed state and the connected state, preventing structural jamming or interlocking failure caused by misoperation further improves the accuracy of ball valve assembly operation and the stability of structural operation.

Preferably, the butt end of the joint body 1 is further provided with at least one second protrusion 14 and at least one second groove 15; the second groove 15 extends along the circumference of the joint body 1; when the butt ends of the two joint bodies 1 are butted, the second protrusion 14 on one joint body 1 is inserted into and screwed into the second groove 15 on the other joint body 1; the first protrusion 11, the first groove 12, the second protrusion 14 and the second groove 15 are spaced apart along the circumference of the joint body 1.

The first protrusion 11 and the second protrusion 14 both extend along the circumference of the joint body 1, and the extension length of the second protrusion 14 is greater than that of the first protrusion 11.

A second bump 14 and a second groove 15 are added to the butt end of the joint body 1, and the first bump 11, the first groove 12, the second bump 14 and the second groove 15 are distributed at intervals along the circumference of the joint body 1, which can form a multi-point fit when the two joint bodies 1 are butted, and greatly improve the overall structural strength and circumferential force uniformity after the butt joint, to avoid looseness or deformation caused by single-point matching force concentration, and at the same time, the extension length of the second bump 14 is greater than that of the first bump 11, which can realize step-by-step positioning and guidance in the process of screwing and docking.

First, the second bump 14 with longer length completes the preliminary guidance and pre-positioning, and then the first bump 11 realizes accurate matching, thus effectively reducing the difficulty of docking assembly and improving the docking efficiency and coaxiality, further enhance the two-way interlocking ball valve assembly in the working state of the connection stability and sealing reliability.

Preferably, the mounting end 221 is provided with a mounting through hole 2211, and the pressing block 41 is arranged in the mounting through hole 2211 in a movable manner; the elastic member is a spring, one end of the spring abuts against the pressing block 41, and the other end abuts against the inner wall of the mounting end 221.

The pressing block 41 is movably arranged in the mounting through hole 2211 of the mounting end 221, which can provide stable movable guidance for the pressing block 41, prevent the pressing block 41 from shaking or tilting during the movement, and ensure the locking The end can be accurately aligned and stuck into the locking groove 131, and a spring is used as an elastic member, one end of the pressing block 41 is made to abut against the inner wall of the mounting end 221, which can stably and reliably provide continuous elastic pushing force for the pressing block 41, and ensure that the pressing block 41 always keeps the tendency of extending outward.

This structural form can not only meet the stable engagement requirement of the locking end to the locking groove 131, but also can rotate the valve handle 22 when it is needed, the smooth unlocking is realized by external force pressing, which effectively improves the working stability and service life of the locking assembly 4, and also makes the locking and unlocking operation of the entire valve handle 22 more portable and reliable.

Preferably, the number of the locking grooves 131 is two, and the two locking grooves 131 respectively correspond to the position of the valve handle 22 in the closed state and the position in the connected state.

Set the number of locking grooves 131 to two and correspond to the closed state position and the connected state position of the valve handle 22 respectively, so that the locking end can be accurately engaged and locked only when the valve handle 22 is rotated to the closed or connected position required for operation, thus avoiding the problems of chaotic positioning and mislocking of the valve handle 22 caused by too many locking grooves 131, at the same time, it can ensure that the valve handle 22 can be stably locked in the closed state and the connected state, and there will be no suspension lock in the middle position, which further improves the accuracy of the valve on-off control and the reliability of the overall interlocking structure.

Preferably, the upper end surface of the unlocking protrusion 321 is an arc-shaped surface or a flat surface.

The upper end surface of the unlocking protrusion 321 is set as an arc surface or a flat surface, which can enable the unlocking protrusion 222 to achieve smooth contact and smooth transition when abutting against the upper end surface of the unlocking protrusion 321, effectively reduce the friction resistance and impact stress between the unlocking protrusion 222 and the unlocking protrusion 321, and avoid the situation of jamming, wear or jamming in the linkage process of the two, at the same time, it can ensure that the rotation of the movable lock 3 is more stable and soft, prolong the service life of the unlocking protrusion 222 and the unlocking protrusion 321, and the two end face forms can meet the stable abutment unlocking requirements and adapt to different working conditions.

The use requirements improve the operation smoothness and structural durability of the two-way interlocking ball valve assembly.

Preferably, the end of the locking end is provided with a guide chamfer.

The end of the locking end is provided with a guide chamfer, which can provide a smooth guiding effect for the locking end to be stuck into the locking groove 131 when the valve handle 22 is rotated to the closed state or the connected state, and reduce the locking end and the annular protrusion 13 The risk of sticking between the inner side walls enables the locking end to slide more smoothly and accurately into the locking groove 131 at the corresponding position to complete the locking, at the same time, it can reduce the rigid impact and contact surface wear when the locking end is matched with the locking groove 131, effectively extend the service life of the locking assembly 4, and improve the operating feel and running stability of the valve handle 22 during the rotation, switching and locking process.

Preferably, the reset elastic member is a torsion spring, the torsion spring is sleeved on the pivot shaft 31, one end of the torsion spring abuts against the joint main body 1, and the other end abuts against the lock hook end 33 of the movable lock catch 3.

The reset elastic member is set as a torsion spring sleeved on the pivot shaft 31, which can make full use of the installation space of the pivot shaft 31, so that the overall structure is more compact and the assembly is stable without occupying additional installation space.

One end of the torsion spring abuts the joint body 1, and the other end abuts the lock hook end 33 of the movable lock buckle 3, which can directly apply stable torsional elastic force to the lock hook end 33, the lock hook end 33 is accurately driven to keep the trend of rotating in the locking direction.

Compared with other elastic structures, the acting force direction of the torsion spring is more closely fitted to the rotation track of the movable lock catch 3, the locking and resetting response is faster, the force is more uniform, and the elastic failure or deviation problem is not easy to occur, which further ensures the reliability of the locking of the movable lock catch 3 to the first protrusion 11 and the timeliness of the resetting action, the long-term operation stability of the two-way interlocking structure is improved.

Preferably, the butt end of the joint body 1 is provided with a sealing groove 16, and a sealing ring 5 is installed in the sealing groove 16 for end face sealing when the two joint bodies 1 are butt-jointed.

The sealing groove 16 is provided at the butt joint end of the joint body 1 and the sealing ring 5 is installed in the sealing groove 16.

After the butt joint locking of the two joint bodies 1 is completed, the elastic deformation of the sealing ring 5 can be used to fill the matching gap between the butt joint end faces, forming a reliable end face sealing structure, effectively preventing fluid leakage from the butt joint gap, and improving the overall sealing performance of the two-way interlocking ball valve assembly, at the same time, the sealing groove 16 can position and restrict the sealing ring 5, so as to prevent the sealing ring 5 from shifting, falling off or squeezing deformation during the docking, screwing or working process, ensure the long-term stability of the sealing effect, and meet the sealing requirements under different fluid transportation conditions.

In the description of the present specification, the description of reference terms such as “one embodiment”, “some embodiments”, “an example”, “a specific example” or “some examples” means that a specific feature, structure, material or characteristic described in combination with the embodiment or example is included in at least one embodiment or example of the present application.

Moreover, the specific features, structures, materials, or characteristics described may be combined in any one or more embodiments or examples in a suitable manner.

In addition, those skilled in the art may combine and combine different embodiments or examples described in this specification and features of different embodiments or examples without contradiction.

In addition, the terms “first” and “second” are only used for descriptive purposes, and cannot be understood as indicating or implying relative importance or implicitly indicating the number of indicated technical features.

Thus, a feature defined with “first” and “second” may explicitly or implicitly include at least one of the feature.

In the description of the present application, the meaning of “multiple” is two or more, unless otherwise specifically defined.

The above descriptions are only specific embodiments of the present application, but the protection scope of the present application is not limited thereto.

Any person skilled in the art can easily think of various changes or replacements within the technical scope disclosed in the present application, which should be covered by the protection scope of the present application.

Therefore, the protection scope of the present application should be subject to the protection scope of the claims.

1. A two-way interlocking ball valve assembly, characterized by comprising:
The joint body, the butt end of the joint body is provided with at least one first protrusion and at least one first groove; the first groove extends along the circumference of the joint body; when the butt ends of the two joint bodies are butted, the first protrusion located on one of the joint bodies is inserted and screwed into the first groove located in the other joint body; the outer wall of the joint body is also provided with an annular protrusion, and the annular protrusion extends circumferentially along the handle mounting hole of the joint body; the inner side wall of the annular protrusion is provided with a plurality of locking grooves, The locking grooves are distributed at intervals along the circumferential direction of the annular protrusion;
A valve assembly, the valve assembly includes a rotary valve, a valve handle, and a connecting shaft; the rotary valve is installed on the joint body; the mounting end of the valve handle is sleeved on the annular protrusion; the connecting shaft passes through the The handle mounting hole, the valve handle is connected to the rotary valve through the connecting shaft; the valve handle can rotate relative to the joint body, to control the rotary valve to switch between a closed state and a connected state; the outer wall of the mounting end is provided with an unlocking protrusion;
The movable lock buckle is pivotally connected to the joint body through a pivot shaft; the pivot shaft extends along the length direction of the joint body, and the movable lock buckle can rotate around the axis of the pivot shaft relative to the joint body; the unlocking end of the movable lock buckle is provided with an unlocking protrusion, and the unlocking protrusion extends along the extension direction of the pivot shaft and extends close to the valve handle; the lock hook end of the movable lock buckle is used to lock the first protrusion of the other joint body that is connected; in the closed state, the unlocking protrusion abuts against the upper end surface of the unlocking protrusion, so that The movable lock buckle rotates to release the lock of the first protrusion; in the connected state, the unlocking protrusion leaves the upper end surface of the unlocking protrusion, the movable locking buckle locks the first bump;
A reset elastic member, the reset elastic member is arranged between the movable lock catch and the pivot shaft, and the reset elastic member is used to drive the lock hook end to maintain a tendency to rotate in the locking direction;
The locking assembly includes a pressing block and an elastic member, the pressing block is movable to the mounting end, and the locking end of the pressing block passes through the outer wall of the mounting end and extends into the inside of the mounting end; the elastic member is clamped by the pressing block and the mounting end, so that the pressing block has a tendency to move away from the mounting end; in the closed state and the connected state, the locking end is locked into the locking groove at the corresponding position to realize the locking of the valve handle.

2. The two-way interlocking ball valve assembly according to claim 1, wherein the outer wall of the mounting end is further provided with a clamping protrusion, and the clamping protrusion extends in a direction away from the mounting end; in the connected state, the clamping protrusion abuts against the lower end surface of the unlocking end; and in the closed state, the clamping protrusion is away from the lower end surface of the unlocking end.

3. The two-way interlocking ball valve assembly according to claim 1, wherein an inner side wall of the mounting end is provided with an escape groove extending along a circumferential direction of the mounting end; an outer wall of the annular protrusion is provided with a limiting protrusion, the limiting protrusion is located in the escape groove, and the limiting protrusion is configured to limit a rotation angle of the valve handle.

4. The two-way interlocking ball valve assembly according to claim 1, wherein at least one second protrusion and at least one second groove are further provided on the butt end of the joint body; the second groove Extend along the circumferential direction of the joint body; when the butt ends of the two joint bodies are connected, the second protrusion located on one of the joint bodies is inserted into and screwed into the second groove located in the other joint body; the first protrusion, the first groove, the second protrusion The block and the second groove are spaced along the circumference of the joint body; the first protrusion and the second protrusion both extend along the circumference of the joint body, and an extension length of the second bump is greater than that of the first bump.

5. The two-way interlocking ball valve assembly according to claim 1, wherein the mounting end is provided with a mounting through hole, and the pressing block is movable in the mounting through hole; the elastic The piece is a spring, one end of the spring abuts against the pressing block, and the other end abuts against the inner wall of the mounting end.

6. The two-way interlocking ball valve assembly according to claim 1, wherein the number of the locking grooves is two, and the two locking grooves respectively correspond to the position of the valve handle in the closed state and the position in the connected state.

7. The two-way interlocking ball valve assembly according to claim 1, wherein the upper end surface of the unlocking protrusion is an arc-shaped surface or a flat surface.

8. The two-way interlocking ball valve assembly according to claim 1, wherein an end of the locking end is provided with a guide chamfer.

9. The two-way interlocking ball valve assembly according to claim 1, wherein the reset elastic member is a torsion spring, and the torsion spring is sleeved on the pivot shaft.

10. The two-way interlocking ball valve assembly according to claim 1, wherein the butt end of the joint body is provided with a sealing groove, and a sealing ring is installed in the sealing groove for two joint bodies. End face sealing when butt joint.
